(19) United States
(12) Patent Application Publication
(10) Pub. No.: US 2024/0271891 A1
(43) Pub. Date: Aug. 15, 2024

(54) TUBULAR BODY FOR A HEAT EXCHANGER, AND A MANUFACTURING PROCESS FOR THE SAME

(71) Applicant: MAHLE INTERNATIONAL GMBH, Stuttgart (DE)

(72) Inventors: Thomas FELDHEGE, Stuttgart (DE); Alexander WALD, Stuttgart (DE); Axel DOLDERER, Stuttgart (DE); Matthias GOERDELER, Stuttgart (DE); Hans-Heinrich ANGERMANN, Stuttgart (DE)

(21) Appl. No.: 18/429,737

(22) Filed: Feb. 1, 2024

(30) Foreign Application Priority Data
Feb. 14, 2023 (DE) 102023201216.2

(51) Int. Cl. F28F 21/08; F28F 1/04

(52) U.S. Cl. CPC F28F 21/084; F28F 1/04; F28F 2275/025

(57) ABSTRACT

The invention relates to a tube, in particular a heat exchanger tube for a heat exchanger, in which the tube comprises two components that are materially bonded to one another with an adhesive bond, which then encompass a tubular interior through which a coolant can flow. At least one of the components comprises an aluminum alloy of the class EN AW-5000, in particular AW-5005, AW-5005a, AW-5049, AW-5052, or AW-5754, containing 0.5% to 4% magnesium by weight. At least one of the components has a bonding agent layer that contains titanium (Ti) and zirconium, at least on its surface where the adhesive bond is formed.

### CROSS-REFERENCE TO RELATED APPLICATIONS

This application claims priority from German Patent Application No. 10 2023 201 216.2, filed Feb. 14 2023, the entirety of which is incorporated by reference herein.

The invention relates to a tubular body for a heat exchanger and a process for manufacturing such a tubular body.

Most tubes for heat exchangers in motor vehicles are made of aluminum, because aluminum has a low density and a high thermal conductivity, such that aluminum is an ideal material for heat exchangers in motor vehicles.

The individual components of heat exchangers are normally soldered together. Soldering aluminum takes place at temperatures above 400° C., which requires a lot of energy to heat these components to this temperature. The aluminum is often annealed through the soldering process, thus becoming weaker.

The object of the invention is to find new ways to develop tubes for heat exchangers. In particular, a better design for such a tube is to be obtained, which is distinguished specifically by the ease of production and an economical use of materials, while still resulting in a longer service life.

This problem is solved according to the invention by the subject matter of the independent and coordinate claims. Advantageous embodiments are the subject matter of the dependent claims.

The fundamental idea of the invention is therefore to create tubes through which a coolant can flow by materially bonding two components made of an aluminum alloy, without soldering, and instead by attaching the two components to one another with an adhesive. Consequently, the components do not need to be heated to 400° C. or more, as is the case with soldering, which results in a weakening of the materials in the components.

The components can therefore be relatively thin-walled, and aluminum alloys can be used that could not be used in the prior art because they are difficult or impossible to solder, but have a high basic strength and can be readily shaped, with which the components, typically made from sheet metal or metal strips, can be easily shaped to obtain the tubes.

According to the invention, at least one of the components is an aluminum alloy from the class EN AW-5000, containing between 0.5% and 4% magnesium by weight. The aluminum alloys in the class EN AW-5000 are relatively strong and laminar, and thus do not become pitted or readily corroded. In comparison with other aluminum alloys, which corrode or become pitted, tubes made of this material have a longer service life.

Because the adhesive bond between the two components must also be durable in order to obtain a tube with a long service life when subjected to chemical, thermal and mechanical, as well as extremely corrosive, conditions, application of a bonding agent layer that contains titanium and zirconium to the surface of at least one of the components, at least where the adhesive bond is to be obtained, is also proposed according to the invention.

This bonding agent layer reinforces the adhesion between the two components and therefore significantly lengthens the service life of the adhesive bond in the desired manner. This ensures that the tubes exhibit the necessary durability and service life, such that they remain intact when exposed to the pressures, as well as the chemical and thermal effects, of the coolant. A thermoplastic adhesive is used to join these components. Preferably, an adhesive with a polyolefin base can be used.

A tube that can be easily produced and has a long service life is created with the steps described above.

In detail, the tube according to the invention for a heat exchanger comprises at least two components that are materially bonded to one another with an adhesive, which can preferably be made from sheet metal. The two components encompass a tubular interior through which a coolant can flow. At least one, preferably both, of the components is made of an aluminum alloy in the class EN AW-5000, in particular AW-5005 or AW-5005A, AW-5049, AW-5052, or AW-5754, containing between 0.5% and 4% magnesium by weight. In the context of the invention, the phrase, “containing an alloy,” is understood to mean that the component in question contains material made of this alloy.

According to the invention, a bonding agent layer is applied to the surface of at least one of the components, at least where the adhesion takes place, which contains both titanium and zirconium. This layer is preferably applied to both components forming the tube. Particularly preferably, the entire surface of one or both components can be coated with this bonding agent layer. This is particularly the case when it is easier to coat the entire component than just a portion thereof.

The weight of the titanium and zirconium in the bonding agent layer regarding is between 3 mg/m² and 30 mg/m² according to the invention.

In a preferred embodiment, the bonding agent layer has between 10% and 30% fluoride atomically, measured with energy-dispersive X-ray spectroscopy at an excitation voltage of 5 kV, or between 3% and 12% atomically, measured with energy-dispersive X-ray spectroscopy at an excitation voltage of 20 kV.

In another preferred embodiment, the aluminum alloy in at least one of the two components of the tube has a maximum of 1% manganese by weight. Adding manganese strengthens the component. Limiting manganese to 1% ensures that the component can still be shaped.

According to an advantageous development, at least one of the components can be plated with a corrosion protection on an inner surface facing the interior of the tube and/or on an outer surface facing away from the interior of the tube. This plating can contain or comprise an aluminum alloy from the class EN AW-1000, in particular EN AW-1050A, and/or EN AW-3000, and/or EN AW-7000. Aluminum alloys in the class EN AW-1000 or AW-3000 are particularly corrosion resistant. Class EN AW-1000 aluminum alloys are also referred to as “pure aluminum.” This aluminum is not particularly strong. The EN AW-1000 alloys are normally strong enough for many applications, however. AW-7000 aluminum alloys also have a further hardening potential. By combining the appropriate classes, the plating can be adjusted to obtain the desired corrosion protection and strength for specific applications.

Particularly effective corrosion protection can also be obtained with a plating that is 2% to 30% of the thickness of the component, in which the thickness of the component is between 0.2 mm and 5 mm.

The mechanical strength of the tube can specifically have at least one of the following values: 50 to 250 MPa Rp₀₂, 100 to 300 MPa Rm, and 5% to 30% breaking elongation A₅₀.

The invention also relates to a method for producing the above tube according to the invention, whereas the above advantages of the tube according to the invention also apply to the method according to the invention.

The method according to the invention comprises two steps a) and b).

In step a), the first and second components are provided in order to be joined together. Furthermore, a bonding agent layer containing titanium and zirconium is applied in step a) to the surface of at least one of the components, at least where they are to be joined together.

The two components are glued together by the adhesive applied to the joining area, such that the components encompass a tubular interior through which a coolant can flow after they have been joined or glued together. The maximum temperature for the joining or gluing is 400° C. In other words, the maximum temperature to which the components and the adhesive are heated in an oven during the joining or gluing is 400° C. By limiting the joining temperature to this maximum, excessive weakening of the aluminum alloy is prevented. A thermoplastic adhesive can be used for the gluing process. Preferably this is an adhesive with a polyolefin base.

In a preferred embodiment, at least one, preferably both, of the components provided in step a) is/are sheet metal. Sheet metals can be easily bent to the desired shape. Furthermore, the component can be advantageously cold-hardened during the shaping process, which can be obtained at the joining temperatures specified above, which are relatively low in comparison to the temperatures of a soldering process.

According to an advantageous development of the method according to the invention, an auxiliary step z) is carried out prior to step b). At least one of the two components, or pieces of sheet metal, is shaped in the course of this auxiliary step z), in particular curved or deep-drawn. The maximum degree of deformation is preferably 50%, particularly preferably 30%.

It is particularly preferred that the maximum temperature for the joining or gluing in step b) is 200° C.

A durable adhesive bond between the components without excessive weakening of the aluminum alloy can be obtained when the joining or gluing process in step b) lasts no longer than 30 minutes, preferably no longer than 15 minutes. This does not include the curing of the adhesive after the joining process.

Strip metal or sheet metal can be used as the raw stock for the component provided in step a).

Other important features and advantages of the invention can be derived from the dependent claims, drawings, and the descriptions of the drawings.

It should be understood that the features specified above and explained below can be used not only in the respective given combinations, but also in other combinations or in and of themselves, without abandoning the framework of the present invention.

Preferred exemplary embodiments of the invention are shown in the drawings and shall be explained below in greater detail, in which the same reference symbols are used for the same, similar, or functionally identical components.

Therein, schematically,

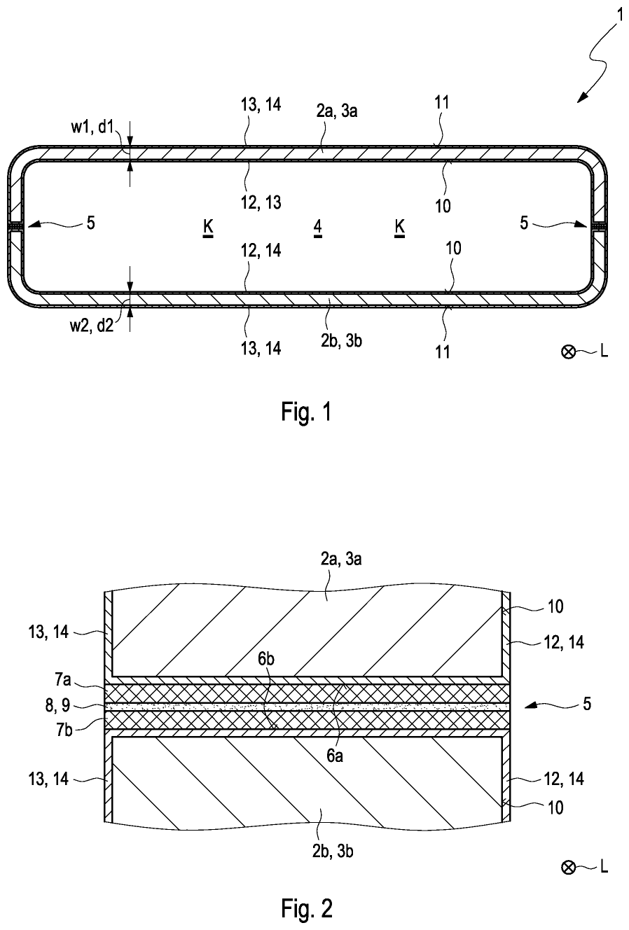

FIG. 1 shows a cross section of an example of a tube according to the invention;

FIG. 2 shows a detail of FIG. 1 where the adhesive bond between the two components of the tube in FIG. 1 is obtained;

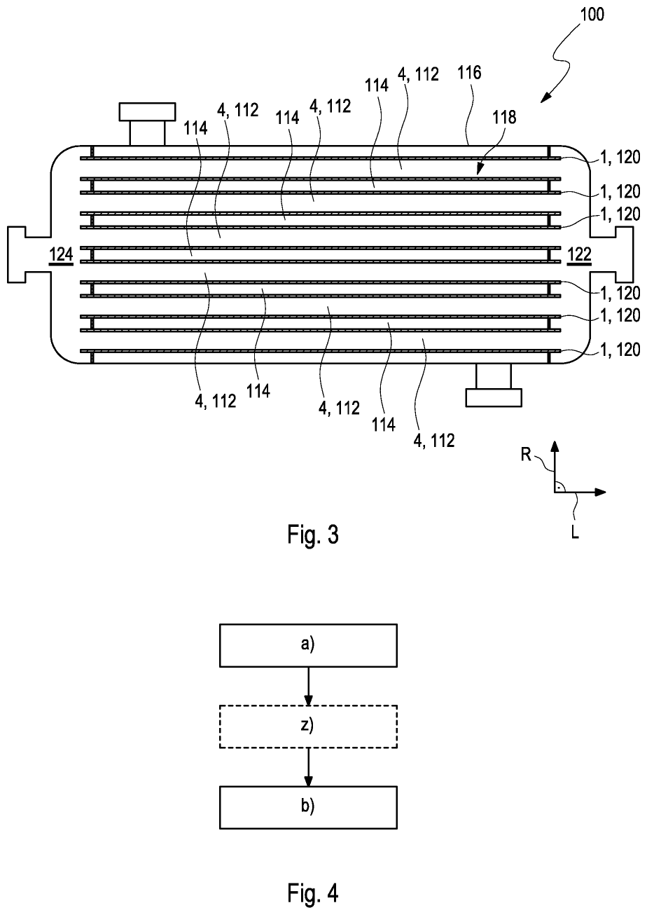

FIG. 3 shows an example of a heat exchanger according to the invention, with numerous tubes according to the invention; and

FIG. 4 shows a flow chart illustrating the method according to the invention in an exemplary manner.

FIG. 1 roughly illustrates an example of a tube 1 according to the invention for a heat exchanger 10 (not shown in FIG. 1) (see FIG. 3). The tube 1 extends in the longitudinal direction L. FIG. 1 shows the tube 1 in a cross section perpendicular to this longitudinal direction L. The tube 1 comprises two components 2a, 2b, formed from sheet metal pieces 3a, 3b in this example. The two components 2a, 2b, or sheet metal pieces 3a, 3b, encompass a tubular interior 4, through which coolant K can flow in the longitudinal direction L. The two components 2a, 2b, or sheet metal pieces 3a, 3b, are materially bonded to one another, or attached to one another, by an adhesive bond 5 that is only roughly indicated in FIG. 1.

The thicknesses d1, d2 of the two components 2a, 2b, which corresponds to the thicknesses w1, w2 of the sheet metal pieces 3a, 3b, can range from 0.2 mm to 5 mm. It is understood that the two components 2a, 2b, or sheet metal pieces 3a, 3b can have the same or different thicknesses d1, d2, or thicknesses w1, w2.

The components 2a, 2b of the tube 1 contain an aluminum alloy from the class EN AW-5000, e.g. AW-5005, AW-5005A, AW-5049, AW-5052, or AW-5754, each of which contains between 0.5% and 4% magnesium by weight.

The aluminum alloy used for the components 2a, 2b can also contain a maximum of 1% manganese by weight. Adding manganese strengthens the components 2a, 2b. By limiting the manganese to a maximum of 1% by weight, it is ensured that the components 2a, 2b can still be shaped as needed. It is understood that the two components 2a, 2b, or sheet metal pieces 3a, 3b can be made with the same or different aluminum alloys, in particular with regard to the magnesium and manganese portions. By way of example, the mechanical durability of the tube 1 can have at least one of the following values: 50-250 MPa Rp₀₂; 100-300 MPa Rm; 5-30% breaking elongation A₅₀.

FIG. 2 shows a detail of FIG. 1, illustrating the adhesive bond 5. A bonding agent layer 7a, 7b containing titanium and zirconium has been applied to the surfaces 6a, 6b of the components 2a, 2b where the adhesive bond 5 is obtained. The adhesive 8 necessary for obtaining the adhesive bond 5 can be sandwiched between the two bonding agent layers 7a, 7b in the form of adhesive layer 9. In another, simplified variation, not shown here, the bonding agent layer 7a, 7b can be placed on just one of the two surfaces 6a, 6b.

The two bonding agent layers 7a, 7b contain both titanium and zirconium, weighing between 3 mg/m² and 30 mg/m² for each element. The bonding agent layers 7a, 7b also contain 10% to 20% fluoride atomically, set by means of energy-dispersive X-ray spectroscopy at an excitation voltage 5 kV, or 3% to 12% atomically, set at an excitation voltage of 20 kV. The two bonding agent layers 7a, 7b can have the same or different compositions.

Reference is made again to FIG. 1 below. The two components 2a, 2b, or sheet metal pieces 3a, 3b can have a plating 12, 13 functioning as corrosion protection 14 on both an inner surface 10 facing the interior 4 of the tube, or an outer surface 11 facing away from the interior 4 of the tube. This plating 12, 13 can be an aluminum alloy from the class EN AW-1000, e.g. EN AW-1050a, and/or EN AW-3000, and/or EN AW-7000. Aluminum alloys in the classes EN AW-1000 and AW-3000 are particularly corrosion resistant. Aluminum alloys in the class EN AW-1000 are also referred to as “pure aluminum.” This type of aluminum is normally not particularly strong. The EN AW-1000 alloys are normally strong enough for numerous applications, however. AW-7000 aluminum alloys also have a further hardening potential. By combining different classes, the respective platings 12, 13 can be adjusted with regard to the desired corrosion protection and strength for specific applications. In this example, the platings 12, 13 have thicknesses between 2% and 30% of the component thicknesses d1, d2 described above, or the respective components 2a, 2b.

The tubes 1 described in reference to FIGS. 1 and 2 can be used as so-called heat exchanger tubes 120 in a heat exchanger 100, the structure of which is illustrated schematically in FIG. 3. The heat exchanger 100 has a first fluid path 112 and second fluid path 114, which run in alternating directions R adjacently to one another at a right angle to the longitudinal direction L. The first and second fluid paths 112, 114 are therefore separated with regard to the fluid flowing through them, and coupled together for heat exchange. Consequently, heat can be exchanged between a first fluid flowing through the first fluid path 112 and a second fluid flowing through the second fluid path 114. The first fluid paths 112 are encompassed by the individual tubes 1 and formed by the interior 4 of the tube 1. The second fluid paths 114 are formed by the spaces between the adjacent tubes 1, i.e. the tubes 1 are spaced apart in the direction R. The first fluid can be the coolant described above.

The heat exchanger 100 has a housing 116 in this example, which encompasses a heat exchanger chamber 118. The first fluid path 112 and second fluid path 114 are formed in the heat exchanger chamber 118. One of the fluid paths, e.g. the first fluid path 112, has numerous heat exchanger tubes 120 formed by the tubes 1 according to the invention, which are flat tubes. The heat exchanger tubes 120, or tubes 1, connect an intake chamber 112 to an outlet chamber 124 for fluid exchange. Fluid that flows through the first fluid path 12 can therefore flow from the intake chamber 122 through the heat exchanger tube 120 to the outlet chamber 124.

The method according to the invention shall be explained below in reference to the flow chart shown in FIG. 4. In this example, the method comprises three successive steps a), z), and b), wherein step z) is optional and is not necessary in a simplified version of the method according to the invention. The first and second components 2a, 2b are provided in order to be joined together in step a), and a bonding agent layer 7a, 7b that contains titanium and zirconium is placed on the surfaces 6a, 6b of the components 2a, 2b where they are to be joined to one another. Both of the components 2a, 2b can be sheet metal pieces.

The two components 2a, 2b are then shaped, e.g. by deep-drawing, in the optional step z), with a maximum degree of deformation of 50%, particularly preferably no more than 30%.

The two components 2a, 2b are then materially bonded to one another with an adhesive 8 applied to the surfaces 6a, 6b on the components 2a, 2b where they are to be joined to obtain a tube 1. After this joining, the two components 2a, 2b then encompass a tubular interior 4 through which a coolant can flow. The components 2a, 2b are glued together when they are heated in an oven to a maximum joining temperature of 400° C., preferably at a maximum of 200° C. The joining process, or gluing in step b) takes place in this example in less than 30 minutes, preferably less than 15 minutes.

The specification can be readily understood with reference to the following Numbered Paragraphs:
Numbered Paragraph 1. A tube (1), in particular a heat exchanger tube (120) for a heat exchanger,
   which has two components (2a, 2b) materially bonded to one another with an adhesive bond (5), preferably made of sheet metal pieces (3a, 3b), which then encompass a tubular interior (4) through which a coolant (K) can flow,
   wherein at least one of the components (2a, 2b) contains an aluminum alloy of the class EN AW-5000, in particular AW-5005, AW-5005A, AW-5049, AW-5052, or AW-5754, with at least 0.5% to 4% magnesium by weight,
   wherein at least one of the components (2a, 2b) has a bonding agent layer (7a, 7b) on its surface (6a, 6b), at least where the adhesive bond (5) is to be formed, which contains titanium (Ti) and zirconium (Zr) with a weight of 3 to 30 mg/m² in each case.
Numbered Paragraph 2. The tube according to Numbered Paragraph 1, characterized in that the bonding agent layer (7a, 7b) contains fluoride, obtained with an energy-dispersion X-ray spectroscopy of 10% to 20% atomically at an acceleration voltage of 5 kV, or 3% to 12% atomically at an acceleration voltage of 20 kV.
Numbered Paragraph 3. The tube according to Numbered Paragraph 1 or 2, characterized in that the aluminum alloy contains a maximum of 1% manganese by weight.
Numbered Paragraph 4. The tube according to any of the preceding Numbered Paragraphs, characterized in that at least one of the components (2a, 2b) has a plating (12, 13) functioning as corrosion protection on an inner surface (10) facing the tubular interior (4), and/or on an outer surface (11) facing away from the tubular interior (4), which contains an aluminum alloy from the class EN AW-1000, in particular EN AW-1050A, EN AW-3000, or EN AW-7000, or is composed of at least one of the aforementioned aluminum alloys.
Numbered Paragraph 5. The tube according to Numbered Paragraph 4, characterized in that the thickness of the plating (12, 13) is between 2% and 30% of the thickness (d1, d2) of the component (2a, 2b) that has this plating (12, 13).
Numbered Paragraph 6. The tube according to any of the preceding Numbered Paragraphs, characterized in that at least one of the components (2a, 2b) has a thickness of 0.2 mm to 5 mm.
Numbered Paragraph 7. The tube according to any of the preceding Numbered Paragraphs, characterized in that the strength of the tube (1) has at least one of the following values:
   50 to 250 MPa Rp₀₂,
   100 to 300 MPa Rm;
   5% to 30% breaking elongation A₅₀.
Numbered Paragraph 8. A method for producing a tube (1) according to any of the preceding Numbered Paragraphs, comprising the following steps:
   a) providing the first and second components (2a, 2b) that are to be joined together, and applying a bonding agent layer (7a, 7b) that contains titanium and zirconium to the surface (6a, 6b) of at least one of the components where these surfaces (6a, 6b) are to be joined in order to join the components (2a, 2b) to one another,
   b) material bonding of the two components (2a, 2b) to obtain the tube (1) by means of an adhesive applied to the surface (6a, 6b) of at least one of the components (2a, 2b) where they are to be joined, such that after the two components (2a, 2b) have been joined, they encompass a tubular interior (4) through which a coolant can flow, wherein the bonding of the two components (2a, 2b) takes place while they are heated, in particular in an oven, to a maximum temperature of no more than 400° C.
Numbered Paragraph 9. The method according to Numbered Paragraph 8, characterized in that at least one, preferably both, of the components (2a, 2b) provided in step a) is a sheet metal piece (3a, 3b).
Numbered Paragraph 10. The method according to Numbered Paragraph 8 or 9, comprising the supplementary step z) carried out at least prior to step b):
   z) shaping, in particular through deep drawing, at least one of the two components (2a, 2b), preferably with a maximum degree of deformation of 50%, particularly preferably no more than 30%.
Numbered Paragraph 11. The method according to any of the Numbered Paragraphs 8 to 10, characterized in that the joining temperature in step b) is no higher than 200° C.
Numbered Paragraph 12. The method according to any of the Numbered Paragraphs 8 to 11, characterized in that the joining process, in particular the gluing, in step b) takes place during a period of no longer than 30 minutes, preferably no longer than 15 minutes.
Numbered Paragraph 13. The method according to any of the Numbered Paragraphs 8 to 12, characterized in that strip metal or sheet metal is used as the raw stock for the components (2a, 2b) provided in step a).

1. A tube, in particular a heat exchanger tube for a heat exchanger, comprising:
two components materially bonded to one another with an adhesive bond, preferably made of sheet metal pieces, the two components bonded one another establish a tubular interior through which a coolant can flow,
wherein at least one of the two components comprises contains an aluminum alloy of the class EN AW-5000, in particular AW-5005, AW-5005A, AW-5049, AW-5052, or AW-5754, with at least 0.5% to 4% magnesium by weight,
wherein at least one of the two components comprises a bonding agent layer on its surface, at least where the adhesive bond is configured to be formed, wherein the bonding agent layer comprises titanium (Ti) and zirconium (Zr) with a weight of 3 to 30 mg/m².

2. The tube according to claim 1, wherein
the bonding agent layer comprises fluoride, obtained with an energy-dispersion X-ray spectroscopy of one of 10% to 20% atomically at an acceleration voltage of 5 kV, or 3% to 12% atomically at an acceleration voltage of 20 kV.

3. The tube according to claim 1, wherein
the aluminum alloy comprises a maximum of 1% manganese by weight.

4. The tube according to claim 1,
wherein at least one of the two components comprises a plating that establishes corrosion protection on an inner surface (10) thereof facing the tubular interior, and/or on an outer surface thereof facing away from the tubular interior, which comprises one of an aluminum alloy from the class EN AW-1000, in particular EN AW-1050A, EN AW-3000, or EN AW-7000, or comprises a combination of two or more of the aforementioned aluminum alloys.

5. The tube according to claim 4, wherein
the thickness of the plating is between 2% and 30% of the thickness (d1, d2) of the component that has this plating.

6. The tube according to claim 1,
wherein at least one of the two components has a thickness of 0.2 mm to 5 mm.

7. The tube according to claim 1,
wherein a strength of the tube has at least one of the following values:
50 to 250 MPa RP₀₂,
100 to 300 MPa RM; or
5% to 30% breaking elongation A₅₀.

8. A method for producing a tube according to claim 1, comprising the following steps:
a) Providing the two components that are to be joined together, and applying a bonding agent layer that contains titanium and zirconium to the surface of at least one of the two components where these surfaces are to be joined in order to join the two components to one another,
b) material bonding of the two components to obtain the tube by means of an adhesive applied to the surface of at least one of the two components where they are to be joined, such that after the two components have been joined, they establish a tubular interior through which a coolant can flow, wherein the material bonding of the two components is performed while the two components are heated, in particular in an oven, to a maximum temperature of no more than 400° C.

9. The method according to claim 8, wherein
at least one, of the two components provided in step a) is a sheet metal piece.

10. The method according to claim 8, comprising a supplementary step z) carried out at least prior to step b);
wherein supplementary step z) comprises shaping, in particular through deep drawing, at least one of the two components, with a maximum degree of deformation of 50%.

11. The method according to claim 8,
wherein the joining temperature in step b) is no higher than 200° C.

12. The method according to claim 8,
wherein the joining process, in particular the gluing, in step b) takes place during a period of no longer than 30 minutes.

13. The method according to claim 8,
wherein strip metal or sheet metal is used as the raw stock for the components provided in step a).

14. The method of claim 12, wherein the gluing in step b) takes place for no longer than 15 minutes.

15. The method of claim 10, wherein supplementary step z) further comprises deep drawing at least one of the two components with a maximum degree of deformation of no more than 30%.

16. The method of claim 9, wherein both of the two components provided in step a) is a sheet metal piece.
